(19) United States
(12) Patent Application Publication
(10) Pub. No.: US 2013/0330583 A1
(43) Pub. Date: Dec. 12, 2013

(54) PROTECTIVE CAP FOR A TERMINAL CONNECTION OF A BATTERY

(71) Applicant: GM GLOBAL TECHNOLOGY OPERATIONS LLC, Detroit, MI (US)

(72) Inventor: Joachim LACROIX, Flonheim (DE)

(21) Appl. No.: 13/900,734

(22) Filed: May 23, 2013

(30) Foreign Application Priority Data
Jun. 6, 2012 (DE) 10 2012 011 170.3

(51) Int. Cl. H01M 2/10

(52) U.S. Cl. CPC H01M 2/1072
USPC 429/65

(57) ABSTRACT

A protective cap for a terminal connection of a battery, a motor vehicle battery, and a battery cable are provided. The protective cap includes a first layer of a non-conductive layer material and a second layer superimposed on the first layer. The first layer and the second layer surround an interior space configured to receive the terminal connection in a shell-shaped manner. The first layer faces the terminal connection and consists of a material with a first modulus of elasticity E1, and the second layer faces away from the terminal connection and consists of a material with a second modulus of elasticity E2, wherein E1<E2.

### CROSS-REFERENCE TO RELATED APPLICATION

This disclosure claims priority to German Patent Application No. 10 2012 011 170.3, filed Jun. 6, 2012, which is incorporated herein by reference in its entirety.

### TECHNICAL FIELD

The technical field relates to a protective cap for a terminal connection of an electrical battery, in particular a motor vehicle battery.

### BACKGROUND

The DE 28 24 463, for example, has disclosed a protective cap for encapsulating the terminal connection of an electrical cell, which comprises an electrically non-conductive flange element which when in use encloses the terminal connection, and which comprises an electrically non-conductive cap section which when in use engages in the flange element so that the terminal connection is encapsulated and the exposed conductive parts thereof are covered. The protective cap, in particular, serves to prevent a motor vehicle battery from short-circuiting caused by conductive tools being dropped inadvertently onto exposed battery terminals during maintenance work on a motor vehicle.

Furthermore the DE 28 14 444 B1 has disclosed a connecting cable for a terminal connection of a battery, which comprises a protective cap 11 (see FIG. 1 or FIG. 2) for a terminal connection made of rubber.

Finally a battery with positive and negative electrodes arranged in a housing with in-between separators and an electrolyte and at least one terminal connection is known from the EP 1 304 751 A2, wherein the terminal connection is provided with a contact protection in the form of a freely rotatable wall of insulating material surrounding the terminal connection, this contact protection comprising at least one slot for inserting a connecting cable. FIG. 2b furthermore discloses a screw cap 10 made of an insulating material, in particular of a hard plastic material.

The disadvantage of the known protective caps for motor vehicle batteries consists in that they get easily broken in case of a crash, such as a frontal crash, and therefore do not offer sufficient protection against electrical short-circuiting (for example if the metal bodywork comes into contact with the battery terminal) thereby resulting in secondary dangers such as fire, explosion, cable fire etc.

It is therefore desirable to provide protective caps in such a way that the above mentioned disadvantages can be substantially avoided. In addition, other objects, desirable features and characteristics will become apparent from the subsequent summary and detailed description, and the appended claims, taken in conjunction with the accompanying drawings and this background.

### SUMMARY

In accordance with an exemplary embodiment, a protective cap for a terminal connection (in particular a positive terminal connection) of an electrical battery is provided. The protective cap is characterized in that it is manufactured from a non-conductive layer material which comprises at least one first layer and a superimposed second layer. The layers surround an interior space configured to receive the terminal connection of the protective cap in a shell-shaped manner. The first layer facing the terminal connection consists of a material with a first modulus of elasticity E1 and the second layer facing away from the terminal connection consists of a material with a second modulus of elasticity E2, wherein E1<E2.

The protective cap prevents that mechanical impacts upon the protective cap, such as they occur during a frontal crash, lead to a destruction of the same and thus to short-circuiting the battery, thereby forestalling the occurrence of the above mentioned secondary dangers.

In this regard, the protective cap is constructed from at least two electrically non-conductive layers, wherein the inner first layer, i.e., the layer lining the interior space of the protective cap, consists of an elastic material, which elastically absorbs mechanical knocks or impacting forces and dampens these accordingly. The second layer arranged on top of the first layer in a shell-shaped manner consists of an electrically non-conductive material which is harder, i.e., in particular is less elastic and preferably distributes any locally impacting forces across the area of the protective cap. In an embodiment, the second layer is made of a material which as far as possible prevents an object from mechanically penetrating in direction of the first layer.

In another embodiment, the protective cap is characterized in that E1 is selected from the range of from about 1×10⁻³ GPa to about 1 GPa, for example, from about 1×10⁻² GPa to about 1×10⁻¹ GPa and in that E2 is selected from the range of from about 10 GPa to about 1×10³ GPa, for example from about 10 GPA to about 1×10² GPa. The modulus of elasticity unit here is Giga Pascal.

In an embodiment, the material of the first layer is rubber, in particular hard rubber, and the material of the second layer is a shock-proof plastic.

In order to ensure sufficient damping of impacting forces the first layer has a corresponding layer thickness. The layer thickness of the first layer is, for example, in the range of from about 5 mm to about 30 mm, for example, from about 5 mm to about 20 mm, such as from about 10 to about 20 mm. The layer thickness required for sufficient damping is, of course, dependent upon the material from which the first layer is made.

In order to avoid penetration of the second layer and in order to achieve an areal distribution of the impacting force, the second layer encompasses, for example, an electrically non-conductive fibrous fabric. Alternatively or additionally such an electrically non-conductive fibrous fabric may be arranged between the first and the second layer.

In an embodiment, the fibrous fabric consists of glass fibers and/or plastic fibers, for example, aramid fibers. There may, of course, be several layers above the first layer which in total fulfill the function of firstly, in case of a frontal crash, substantially preventing a penetration of the layers or of a metal part of the vehicle down to the first layer and, in addition, of a really distributing a quasi localized impacting force upon the outer layers within the outer layers such that the force effect per area is diminished.

Further, in an embodiment, a motor vehicle battery with a protective cap such as described above is provided. The protective cap is preferably configured as a loose part which can be detachably firmly connected with the motor vehicle battery or is already connected to the battery, wherein the connection is configured such that a battery cable can be connected to, or disconnected from, the battery terminal, as required.

In another embodiment, a battery cable for connection with a motor vehicle battery, wherein the battery cable comprises a protective cap as described above, is provided.

### BRIEF DESCRIPTION OF THE DRAWINGS

The various embodiments will hereinafter be described in conjunction with the following drawing figures, wherein like numerals denote like elements, and wherein:

FIG. 1 shows a top view of a schematically drawn motor vehicle battery with a protective cap according to an exemplary embodiment, and

FIG. 2 shows a cross-sectional view of the battery of FIG. 1.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

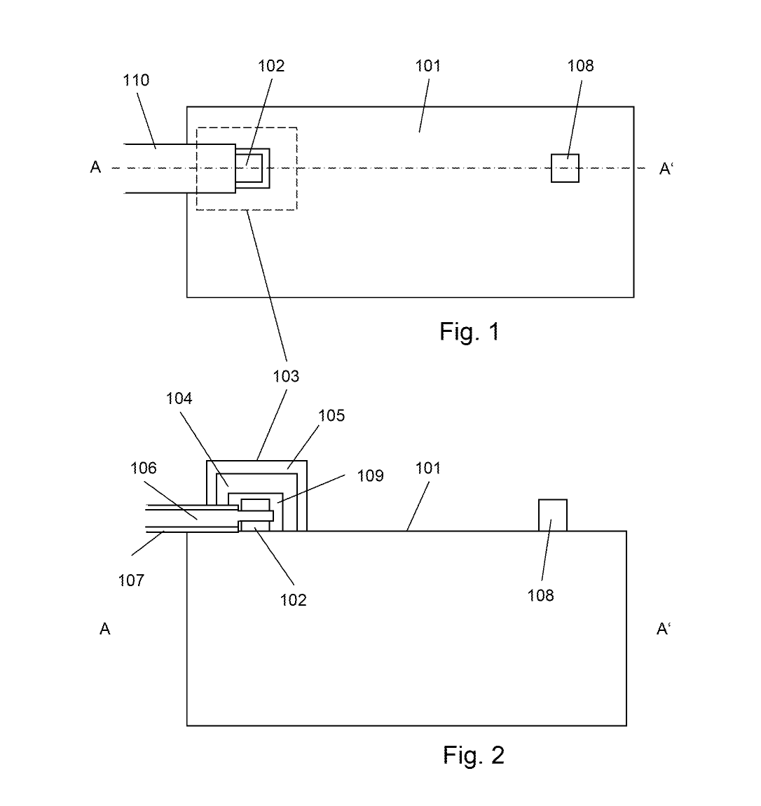

FIG. 1 shows a top view of a schematically drawn motor vehicle battery 101 of a protective cap 103 according to an exemplary embodiment. The motor vehicle battery 101 comprises a positive battery terminal 102 and a negative battery terminal 108. The positive battery terminal 102 is connected to a battery cable 110. The positive battery terminal 102 is protected with a protective cap 103 according to an embodiment. FIG. 1 also shows a cross-sectional axis A-A′.

FIG. 2 shows a schematically drawn cross-sectional view of the battery of FIG. 1. The positive battery terminal 102 is connected to the battery cable 110, which comprises a metal core and a surrounding insulation. The layered construction of the protective cap 103 can be clearly recognized. The protective cap 103 is manufactured from a non-conductive layer material comprising a first layer 104 and a superimposed second layer 105, wherein the layers 104, 105 surround an interior space 109 of the protective cap 103 configured to receive the terminal connection 102, in a shell-shaped manner, and wherein the first layer 104 facing the terminal connection 102 consists of hard rubber with a first modulus of elasticity E1, and the second layer 105 facing away from the terminal connection 102 and comprising a second modulus of elasticity E2 consists of a shock-proof plastic material with a built-in aramid fibrous fabric, wherein E1<E2.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A protective cap for a terminal connection of a battery, wherein the protective cap comprises:
a first layer of a non-conductive layer material; and
a second layer superimposed on the first layer, wherein
the first layer and the second layer surround an interior space configured to receive the terminal connection in a shell-shaped manner, and
wherein the first layer faces the terminal connection and consists of a material with a first modulus of elasticity E1, and the second layer faces away from the terminal connection and consists of a material with a second modulus of elasticity E2, wherein E1<E2.

2. The protective cap according to claim 1, wherein E1 is selected from the range of from about 1×10⁻³ GPa to about 1 GPa and E2 is selected from the range of from about 10 GPa to about 1×10³ GPa.

3. The protective cap according to claim 1, wherein the first layer comprises rubber and the second layer comprises a shock-proof plastic.

4. The protective cap according to claim 1, wherein the first layer has a layer thickness in the range of from about 5 mm to about 30 mm.

5. The protective cap according to claim 1, wherein the second layer comprises an electrically non-conductive fibrous fabric.

6. The protective cap according to claim 1, wherein an electrically non-conductive fibrous fabric is arranged between the first layer and the second layer.

7. The protective cap according to claim 5, wherein the non-conductive fibrous fabric comprises glass fibers and/or plastic fibers and/or aramid fibers.

8. A motor vehicle battery with a protective cap, wherein the protective cap comprises:
a first layer of a non-conductive layer material; and
a second layer superimposed on the first layer,
wherein the first layer and the second layer surround an interior space configured to receive the terminal connection in a shell-shaped manner, and
wherein the first layer faces the terminal connection and consists of a material with a first modulus of elasticity E1, and the second layer faces away from the terminal connection and consists of a material with a second modulus of elasticity E2, wherein E1<E2.

9. A battery cable for connection to a motor vehicle battery with a protective cap comprising:
a first layer of a non-conductive layer material; and
a second layer superimposed on the first layer,
wherein the first layer and the second layer surround an interior space configured to receive the terminal connection in a shell-shaped manner, and
wherein the first layer faces the terminal connection and consists of a material with a first modulus of elasticity E1, and the second layer faces away from the terminal connection and consists of a material with a second modulus of elasticity E2, wherein E1<E2.

10. The protective cap according to claim 2, wherein E1 is selected from the range of from about 1*10⁻² GPa to about 1*10⁻¹ GPa.

11. The protective cap according to claim 2, wherein E2 is selected from the range of from about 10 GPA to 1×10² GPa.

12. The protective cap according to claim 3, wherein the first layer comprises hard rubber.

13. The protective cap according to claim 4, wherein the first layer has a layer thickness in the range of from about 5 mm to about 20 mm.

14. The protective cap according to claim 13, wherein the first layer has a layer thickness in the range of from about 10 mm to about 20 mm.

15. The motor vehicle battery according to claim 8, wherein E1 is selected from the range of from about 1×10⁻³ GPa to about 1 GPa and E2 is selected from the range of from about 10 GPa to about 1×10³ GPa.

16. The motor vehicle battery according to claim 8, wherein the first layer comprises rubber and the second layer comprises a shock-proof plastic.

17. The motor vehicle battery according to claim 8, wherein the first layer has a layer thickness in the range of from about 5 mm to about 30 mm.

18. The motor vehicle battery according to claim 8, wherein the second layer comprises an electrically non-conductive fibrous fabric.

19. The motor vehicle battery according to claim 8, wherein an electrically non-conductive fibrous fabric is arranged between the first layer and the second layer.

20. The motor vehicle battery according to claim 8, wherein the non-conductive fibrous fabric comprises glass fibers and/or plastic fibers and/or aramid fibers.
